(19) United States
(12) Patent Application Publication
(10) Pub. No.: US 2025/0125450 A1
(43) Pub. Date: Apr. 17, 2025

(54) BATTERY PACK CONTAINER ASSEMBLY THAT HOLDS A MIXTURE OF AGENTS

(71) Applicant: Ford Global Technologies, LLC, Dearborn, MI (US)

(72) Inventors: Bhaskara Rao Boddakayala, Troy, MI (US); Di Zhu, Novi, MI (US); Daryl Arnell Marlow, Dearborn, MI (US); Tyler William Roe, Brownstown, MI (US)

(21) Appl. No.: 18/814,254

(22) Filed: Aug. 23, 2024

Related U.S. Application Data
(60) Provisional application No. 63/543,544, filed on Oct. 11, 2023.

(51) Int. Cl. H01M 10/6595; H01M 10/625; H01M 10/647; H01M 50/209; H01M 50/249

(52) U.S. Cl. CPC H01M 10/6595; H01M 10/625; H01M 10/647; H01M 50/209; H01M 50/249

(57) ABSTRACT

A battery pack assembly includes a container assembly that holds a mixture of agents. The container assembly configured to release the mixture of agents in response to a thermal event proximate the container assembly. The mixture of agents can include sodium silicate granules, one or more ceramic-based beads, aluminum oxide particles, melamine poly (zinc phosphate), and aluminum tri-hydrate.

### CROSS-REFERENCE TO RELATED APPLICATIONS

This application claims the benefit of U.S. Provisional Application No. 63/543,544, which was filed on 11 Oct. 2023 and is incorporated herein by reference.

### BACKGROUND

A high voltage traction battery pack can power the electric machines and other electrical loads of an electrified vehicle. The traction battery pack can include a plurality of individual battery cells. The traction battery pack can, from time to time, experience a thermal event where one or more of the battery cells vent and expel battery vent byproducts. The vent byproducts can include gases and effluent particles.

### SUMMARY

In some aspects, the techniques described herein relate to a battery pack assembly, including: a container assembly that holds a mixture of agents, the container assembly configured to release the mixture of agents in response to a thermal event proximate the container assembly.

In some aspects, the techniques described herein relate to a battery pack assembly, wherein the mixture of agents includes sodium silicate.

In some aspects, the techniques described herein relate to a battery pack assembly, wherein the mixture of agents further includes silicon dioxide and aluminum oxide.

In some aspects, the techniques described herein relate to a battery pack assembly, wherein the mixture of agents includes from 25 to 40 percent sodium silicate.

In some aspects, the techniques described herein relate to a battery pack assembly, wherein the sodium silicate includes sodium silicate granules each having a diameter that is from 5 to 100 microns.

In some aspects, the techniques described herein relate to a battery pack assembly, wherein the mixture of agents includes one or more ceramic-based compounds.

In some aspects, the techniques described herein relate to a battery pack assembly, wherein the one or more ceramic-based compounds includes zirconium dioxide, aluminum oxide, silicon dioxide, or some combination of these.

In some aspects, the techniques described herein relate to a battery pack assembly, wherein the one or more ceramic-based compounds includes more than 10 percent zirconium dioxide, more than 45 percent aluminum oxide, and more than 40 percent silicon dioxide.

In some aspects, the techniques described herein relate to a battery pack assembly, wherein the one or more ceramic-based compounds includes provided by a plurality of beads of the one or more ceramic-based compounds.

In some aspects, the techniques described herein relate to a battery pack assembly, wherein the plurality of beads each have a diameter that is from 2 to 3 millimeters.

In some aspects, the techniques described herein relate to a battery pack assembly, wherein the mixture of agents includes from 25 to 40 percent beads that are ceramic-based.

In some aspects, the techniques described herein relate to a battery pack assembly, wherein the mixture of agents includes a plurality of aluminum oxide particles having diameters ranging from 5 to 30 microns.

In some aspects, the techniques described herein relate to a battery pack assembly, wherein the mixture of agents includes from 5 to 10 percent aluminum oxide particles.

In some aspects, the techniques described herein relate to a battery pack assembly, wherein the mixture of agents includes melamine poly (zinc phosphate).

In some aspects, the techniques described herein relate to a battery pack assembly, wherein the mixture of agents includes from 5 to 10 percent melamine poly (zinc phosphate).

In some aspects, the techniques described herein relate to a battery pack assembly, wherein the mixture of agents includes aluminum tri-hydrate.

In some aspects, the techniques described herein relate to a battery pack assembly, wherein the mixture of agents includes from 3 to 5 percent aluminum tri-hydrate.

In some aspects, the techniques described herein relate to a battery pack assembly, including: a mixture of sodium silicate granules, one or more ceramic-based beads, aluminum oxide particles, melamine poly (zinc phosphate), and aluminum tri-hydrate; and a container assembly that holds a mixture of agents, the container assembly configure to release the mixture of agents in response to a thermal event proximate the container assembly.

In some aspects, the techniques described herein relate to a battery pack assembly, wherein the mixture includes from 25 to 30 percent sodium silicate granules, 25 to 40 percent ceramic-based beads, 5 to 10 percent aluminum oxide particles, 5 to 8 percent melamine poly (zinc phosphate), and 3 to 5 percent aluminum tri-hydrate.

In some aspects, the techniques described herein relate to a battery pack assembly, wherein the one or more ceramic-based beads includes more than 10 percent zirconium dioxide, more than 45 percent aluminum oxide, and more than 40 percent silicon dioxide.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 1.

FIG. 3 illustrates an example container assembly that can release a mixture of agents

FIG. 4 schematically illustrates a top view of a portion of one of the battery arrays of FIG. 2 and shows how container assemblies, such as the container assembly of FIG. 3, could be incorporated into a battery pack.

### DETAILED DESCRIPTION

An battery pack can include at least one container assembly that can release a mixture of agents during a thermal event. The released agents help to suppress the thermal events from cascading through the battery pack. This disclosure is directed toward particular combinations of agents used in such container assemblies.

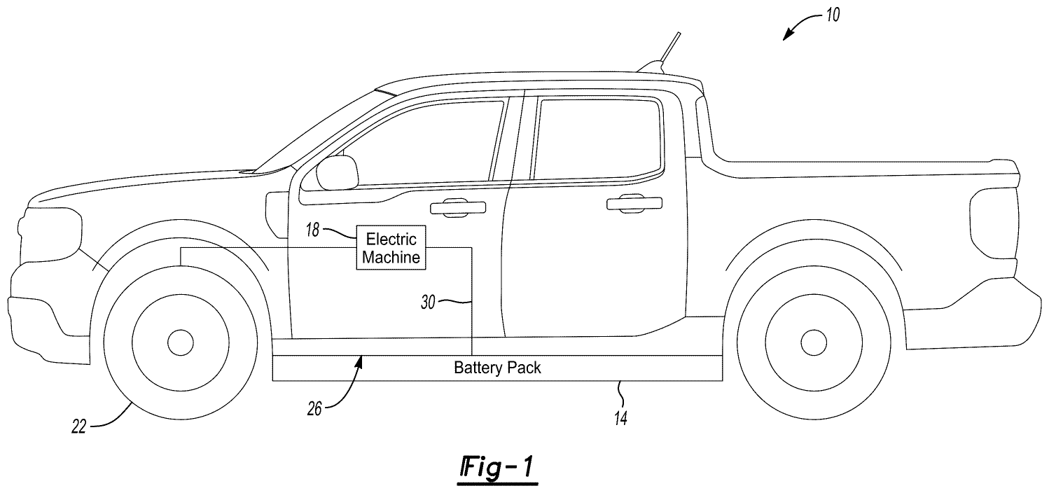

With reference to FIG. 1, an electrified vehicle 10 includes a battery pack 14, an electric machine 18, and wheels 22. The battery pack 14 powers an electric machine 18, which can convert electrical power to mechanical power to drive the wheels 22. The battery pack 14 is thus a traction battery pack.

The battery pack 14 is, in the exemplary embodiment, secured to an underbody 26 of the electrified vehicle 10. The battery pack 14 could be located elsewhere on the electrified vehicle 10 in other examples. A voltage bus 30 electrically couples the electric machine 18 to the traction battery pack 14.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

In the illustrated embodiment, the electrified vehicle 10 is a full electric vehicle propelled solely through electric power, such as by one or more electric machines 18, without assistance from an internal combustion engine. The electric machine 18 may operate as an electric motor, an electric generator, or both. The electric machine 18 receives electrical power and can convert the electrical power to torque for driving one or more wheels 22 of the electrified vehicle 10.

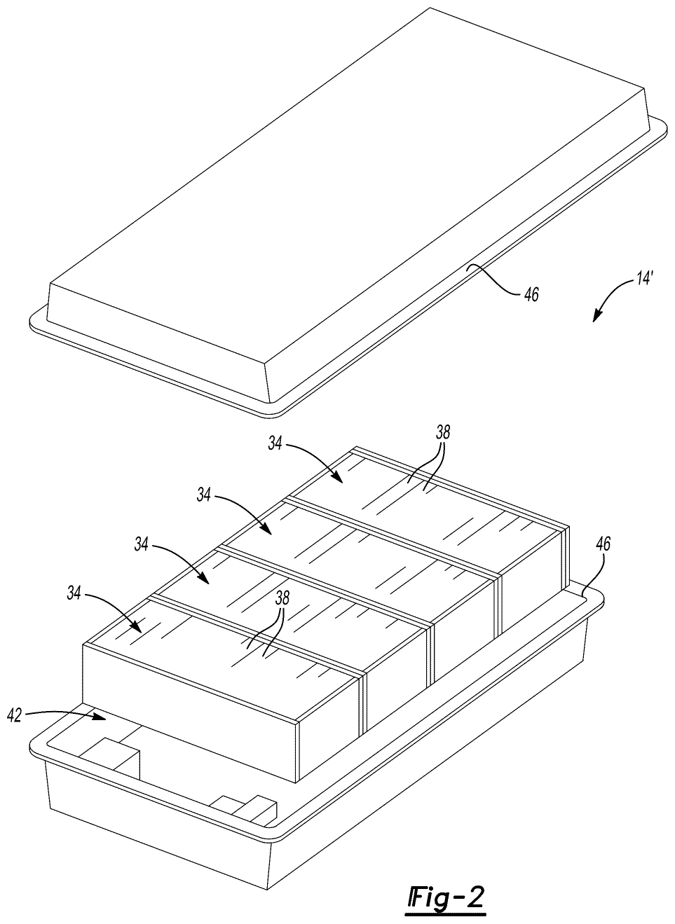

With reference to FIG. 2 and continued reference to FIG. 1, the example traction battery pack 14 includes battery arrays 34 capable of outputting electrical power to power the electric machine 18 and/or other electrical loads of the electrified vehicle 10. Other types of energy storage devices and/or output devices could alternatively or additionally be used to electrically power the electrified vehicle 10.

The one or more battery arrays 34 of the traction battery pack 14 each include a plurality of battery cells 38 that store energy for powering various electrical loads of the electrified vehicle 10. Each of the battery arrays 34 includes, among other things, battery cells 38 (or simply “cells”) stacked side-by-side relative to each along a respective battery array axis. The battery cells 38 store and supply electrical power. Although a specific number of the battery arrays 34 and cells 38 are illustrated in the various figures of this disclosure, the battery pack 14 could include any number of the battery arrays 34 each having any number of individual cells 38.

The traction battery pack 14 could employ any number of battery cells 38 within the scope of this disclosure. Accordingly, this disclosure should not be limited to the highly schematic configuration shown in FIG. 1.

In an embodiment, the battery cells 38 of each battery array 34 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery arrays 34 and various other battery internal components (e.g., bussed electrical center, battery electric control module, wiring, connectors, etc.) may be housed within an interior area 42 of an enclosure assembly 46. The enclosure assembly 46 may include an enclosure cover and an enclosure tray, for example. The enclosure cover may be secured (e.g., bolted, welded, adhered, etc.) to the enclosure tray to provide the interior area 42. The size, shape, and overall configuration of the enclosure assembly 46 is not intended to limit this disclosure.

One or more of the battery cells 38 may periodically release vent byproducts through a vent. Pressure increases within one of the battery cells 38 can cause a case of the battery cells 38 to rupture creating the vent that provides a path for the vent byproducts to be released from inside the battery cell. This disclosure is primarily directed to thermal suppression systems designed for managing the transfer of thermal energy when one or more of the battery cells 38 release vent byproducts.

As explained in further detail below, the battery arrays 34 and the remaining portions of the battery pack 14 may incorporate features designed for managing the cell-to-cell transfer of thermal energy, particularly thermal energy transfer across the battery array 34.

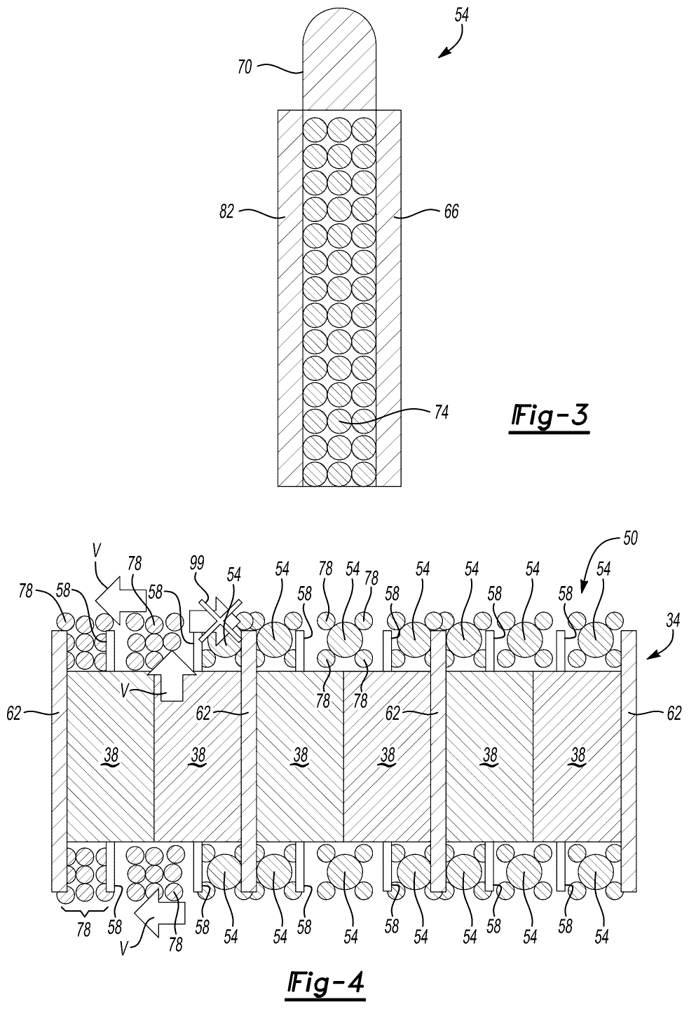

Referring now to FIGS. 3 and 4 with continuing reference to FIGS. 1 and 2, the example battery arrays 34 include a thermal suppression system 50 for managing the transfer of thermal energy across the battery arrays 34. The example thermal suppression system 50 includes a plurality of container assemblies 54 that can be strategically positioned within the battery array 34 for managing the transfer of thermal energy during venting events. For example, among other benefits, the container assemblies 54 may be configured to mitigate the cell-to-cell and/or array-to-array transfer of thermal energy when one or more of the battery cells 38 within the battery arrays 34 release vent byproducts V.

Each container assembly 54, in this example, include a housing 66, a cap 70, and a mixture of agents 74 contained within the housing 66 by the cap 44. The container assemblies 54 of the thermal suppression system 50 can be arranged within a void space located within the battery array 34. In an embodiment, at least some of the container assemblies 54 are positioned between cell tab terminals 58 of adjacent battery cells 38. In another embodiment, at least some of the container assemblies 54 are positioned between the cell tab terminal 58 of one of the battery cells 38 and a cell-to-cell barriers 62 of the battery array 34. However, other arrangements are contemplated within the scope of this disclosure, and it should be understood that the container assemblies 54 could be arranged within any void space of the battery array 34 where it is desirable to limit the transfer of thermal energy.

In some examples, the container assemblies 54 could be integrated within another component of the battery pack 14. For example, a frame of a bus bar module could be formed to include a plurality of pockets that provide containers. A mixture of agents can be contained within an interior volume provided by each of the pockets. A cap or a hinged lid that is integrated with the frame can hold the thermal suppression agent within the pockets.

The housing 66 may include any shape (e.g., cylindrical, rectangular, spherical, etc.) and may be made of a suitable polymeric material (e.g., polypropylene, polyethylene, silicone, TPV, acrylic, or some combination of these). The housing 66 includes support feet 82 that aid in positioning and securing the container assembly 54 within the desired void space (e.g., between adjacent cell tab terminals 58) of the battery array 34. In other examples, the housing 66 does not include support feet 82.

The cap 70 may include any shape (e.g., oval, long oval, trapezoidal, etc.) and may be made from either the same material or a different material than the housing 66. The cap 70 may be made of polypropylene, silicone, ethylene propylene diene monomer (EPDM) rubber, thermoplastic elastomer (TPE), etc.

The mixture of agents 78 is, in this example, held within a hollow interior volume established by the housing 66. The mixture of agents 78 may be made of a high temperature material such as solid silica, aerogel, mica, basalt, etc. The mixture of agents 78 can be provided in either bead, particulate, and/or powder form, for example.

The plurality of container assembles 54 are each configured to release the mixture of agents 78 in response to a thermal event that is proximate that container assembly 54. The housing 66, the cap 70, or both may be designed to melt, rupture or otherwise deform to release the mixture of agents 74 when exposed to temperatures that exceed a predefined temperature threshold (e.g., between 150 and 250 degrees Celsius). Such temperatures may be present, for example, when one or more battery cells 38 near the container assembly 54 experiences a thermal event and is venting the vent byproducts V. Once released, the mixture of agents 74 may capture or trap particles associated with the vent byproducts V, thereby managing or even preventing the transfer of thermal energy toward the non-venting battery cells 38 of the battery array 34 (schematically illustrated at reference numeral 99 in FIG. 3). The non-ruptured container assemblies 54 may also reduce movement of the vent byproducts V toward the non-venting battery cells 38 of the battery array 34.

The mixture of agents 78 that are releases can include endothermic materials and materials that help to electrically isolate. Example materials can include sodium silicate, a ceramic-based compound, melamine poly (zinc phosphate), aluminum tri-hydrate, and silicon dioxide. Other potential agents included within the mixture of agents 78 could include silica, mica, basalt, aerogels, etc.

The sodium silicate can help to absorb thermal energy. The sodium silicate can be in granular form. The granules of sodium silicate can have a diameter that is from 5 to 100 microns. In an example embodiment, from 25 to 40 percent of the mixture of agents is sodium silicate.

The ceramic-based compound can include zirconium dioxide, aluminum oxide, and silicon dioxide. The ceramic-based compound can have the form of beads that have a diameter ranging from 2 to 3 millimeters. In the example embodiment, 25 to 40 percent of the mixture of agents 78 is provided by beads of ceramic-based compound. The ceramic-based compound can include more than 10 percent zirconium dioxide, more than 45 percent with aluminum oxide and more than 40 percent of silicon dioxide. The aluminum oxide can help to electrically isolate during the thermal event.

In other examples, the ceramic-based compound is 100 percent silicon dioxide and the zirconium dioxide and aluminum oxide are omitted.

The mixture of agents 78 can include additional aluminum oxide (outside the ceramic-based compound) that acts a filler agent between the beads of the ceramic-based compound. The additional aluminum oxide can be particles having diameters ranging from 5 to 30 microns. The additional aluminum oxide can “fill in the gaps” between larger beads and particles within the mixture of agents 78. Again, the aluminum oxide can help to electrically isolate during the thermal event. In the example embodiment, 5 to 10 percent of the mixture of agents 78 is filler aluminum oxide.

The melamine poly (zinc phosphate) can help to generate nitrogen gas to arrest oxygen generated from electrodes during the thermal event where vent byproducts V are released from within one or more of the battery cells 38. Reducing available oxygen can help to suppress a thermal event cascading through the battery cells 38 of the battery pack 14.

In the example embodiment, 5 to 8 percent of the mixture of agents is melamine poly (zinc phosphate). The melamine poly (zinc phosphate) can catalyze formation of a layer that supports an effective intumescent effect. The melamine poly (zinc phosphate) can act as a synergist to support suppression of airborne particulates during the thermal event. The melamine poly (zinc phosphate) can act as a heat sink due to endothermal decomposition. The melamine poly (zinc phosphate) can assist with electrical isolation during the thermal event particularly with respect to the vent byproducts V and surrounding components.

The aluminum tri-hydrate can endothermically react during the thermal event to help to reduce temperatures during the thermal event, particularly temperatures of the vent byproducts V. In an example embodiment, 3 to 5 percent of the mixture of agents is aluminum tri-hydrate.

In other examples, the aluminum tri-hydrate is omitted from the mixture of agents 78 and is not included within the container assembly 54.

In an example, the mixture of agents 78 having silicon dioxide, aluminum oxide, and sodium silicate, beads of the silicon dioxide are significantly larger than the particles of aluminum oxide and sodium silicate.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack assembly, comprising:
a container assembly that holds a mixture of agents, the container assembly configured to release the mixture of agents in response to a thermal event proximate the container assembly.

2. The battery pack assembly of claim 1, wherein the mixture of agents comprises sodium silicate.

3. The battery pack assembly of claim 2, wherein the mixture of agents further comprises silicon dioxide and aluminum oxide.

4. The battery pack assembly of claim 1, wherein the mixture of agents comprises from 25 to 40 percent sodium silicate.

5. The battery pack assembly of claim 4, wherein the sodium silicate comprises sodium silicate granules each having a diameter that is from 5 to 100 microns.

6. The battery pack assembly of claim 1, wherein the mixture of agents comprises one or more ceramic-based compounds.

7. The battery pack assembly of claim 6, wherein the one or more ceramic-based compounds comprises zirconium dioxide, aluminum oxide, silicon dioxide, or some combination of these.

8. The battery pack assembly of claim 6, wherein the one or more ceramic-based compounds comprises more than 10 percent zirconium dioxide, more than 45 percent aluminum oxide, and more than 40 percent silicon dioxide.

9. The battery pack assembly of claim 6, wherein the one or more ceramic-based compounds comprises provided by a plurality of beads of the one or more ceramic-based compounds.

10. The battery pack assembly of claim 9, wherein the plurality of beads each have a diameter that is from 2 to 3 millimeters.

11. The battery pack assembly of claim 1, wherein the mixture of agents comprises from 25 to 40 percent beads that are ceramic-based.

12. The battery pack assembly of claim 1, wherein the mixture of agents comprises a plurality of aluminum oxide particles having diameters ranging from 5 to 30 microns.

13. The battery pack assembly of claim 12, wherein the mixture of agents comprises from 5 to 10 percent aluminum oxide particles.

14. The battery pack assembly of claim 1, wherein the mixture of agents comprises melamine poly (zinc phosphate).

15. The battery pack assembly of claim 1, wherein the mixture of agents comprises from 5 to 10 percent melamine poly (zinc phosphate).

16. The battery pack assembly of claim 1, wherein the mixture of agents comprises aluminum tri-hydrate.

17. The battery pack assembly of claim 1, wherein the mixture of agents comprises from 3 to 5 percent aluminum tri-hydrate.

18. A battery pack assembly, comprising:
a mixture of sodium silicate granules, one or more ceramic-based beads, aluminum oxide particles, melamine poly (zinc phosphate), and aluminum tri-hydrate; and
a container assembly that holds the mixture, the container assembly configure to release the mixture in response to a thermal event proximate the container assembly.

19. The battery pack assembly of claim 18, wherein the mixture comprises from 25 to 30 percent sodium silicate granules, 25 to 40 percent ceramic-based beads, 5 to 10 percent aluminum oxide particles, 5 to 8 percent melamine poly (zinc phosphate), and 3 to 5 percent aluminum tri-hydrate.

20. The battery pack assembly of claim 19, wherein the one or more ceramic-based beads comprises more than 10 percent zirconium dioxide, more than 45 percent aluminum oxide, and more than 40 percent silicon dioxide.
